(19) United States
(12) Patent Application Publication
(10) Pub. No.: US 2001/0022235 A1
(43) Pub. Date: Sep. 20, 2001

(54) Monolithic insulating bushing

(76) Inventors: Giorgio Villa, Milan (IT); Giancarlo Villa, Milan (IT)

Correspondence Address: HARNESS, DICKEY & PIERCE, PLC, P.O. BOX 828, BLOOMFIELD HILLS, MI, 48303, US

(21) Appl. No.: 09/811,337

(22) Filed: Mar. 16, 2001

(30) Foreign Application Priority Data
Mar. 17, 2000 (IT) MI2000U 000161

(51) Int. Cl. H01B 17/58

(52) U.S. Cl. 174/167

(57) ABSTRACT

Insulating bushing in which the external insulating casing consists of a single monolithic insulating tube (27) on which the flange (28), the upper insulating ring (26) and a lower electrode (29) are assembled by gluing. This obviates the use of intermediate seals required by the prior art in which the insulating casing is made in a plurality of pieces, these seals being a possible source of leakage. The whole assembly is more resistant to mechanical stresses caused by seismic events or internal short circuits; it is also safer, lighter and more economical.

### BACKGROUND AND SUMMARY OF THE INVENTION

The present patent relates to insulating bushings, generally of the capacitance graded type, wound with a continuous sheet of paper or plastic material and impregnated with liquid or gaseous insulating fluid.

Such insulating bushings are used as insulating outputs of transformers, circuit breakers, and rotating generators, in insulated passages through walls and roofs or in insulated passages through armoured equipment filled with pressurized insulating gas (G.I.S., G.I.L.).

These insulating bushings have various drawbacks, as will be clarified subsequently. The present patent is capable of eliminating these drawbacks.

### BRIEF DESCRIPTION OF THE DRAWINGS

The invention is described below with reference to the attached drawings, in which:

FIG. 1 shows, in section along an axial plane, a known type of insulating bushing; and

FIG. 2 shows, in section along an axial plane, an embodiment of insulating bushing according to the present invention.

### DESCRIPTION OF THE PREFERRED EMBODIMENT

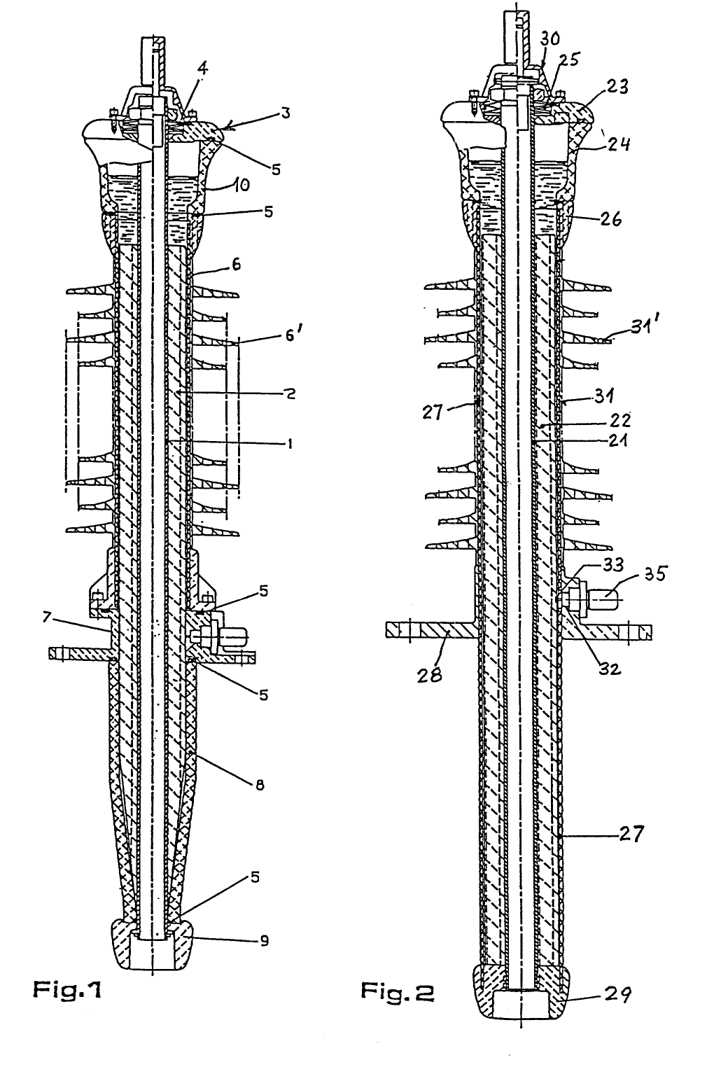

In the present state of the art this type of insulating bushing, an example of which is shown in FIG. 1, consists of a central conductor 1, an insulating body 2 generally of the capacitance graded type, and an upper end, consisting of the cover 3 and the expansion vessel 10, within which are fitted springs 4 which have the function of keeping the external components of the insulating bushing compressed and sealed, by means of suitable seals 5, the external components of the insulating bushing comprising, in addition to the upper end, an upper insulating envelope 6 (generally made from porcelain or from a glass fibre tube provided with sheds 6′ of polymer material), a flange 7, a lower insulating casing 8 and a lower electrode 9.

Another known form of assembly of the insulating bushing not illustrated but essentially similar to that shown in FIG. 1 does not include the spring 4 but in this case the upper end, the porcelain casing, the flange and the lower parts are fixed together by gluing or cementing.

These conventional solutions have the following drawbacks in certain specific applications:

the structure, being formed from a plurality of assembled elements with numerous interposed seals, can prove to be weak in the presence of powerful mechanical stresses such as those due to seismic events, electrodynamic forces due to short circuits of the equipment on which they are fitted, or anomalous mechanical stresses due to particular operating conditions which can cause the fracture of some components;

moreover the seals, which are interposed between the parts, can easily lose their capacity to retain the insulating fluid because of a localized reduction of the joint compression which, in normal conditions only, is applied uniformly over their whole surface; in this case there may be leakage of the insulating fluid (liquid or gas), which weakens the electrical properties of the equipment, sometimes causing the discharge of the insulating brushing and its consequent destruction;

the use of insulating elements made from polymer-coated glass fibre can avoid the breakage of the insulating component (porcelain or castings of epoxy or cycloaliphatic resin), but do not prevent the insulating fluid leakage.

The object of the insulating bushing described in the present patent is to avoid this leakage phenomenon besides the previously mentioned disadvantages which can lead to the explosion of the insulating bushing and to the service blackout on the electrical line to which it is connected.

The insulating bushing according to the invention, shown in FIG. 2, is formed by a central conductor 21, an insulating body 22 generally of the capacitance graded type, an upper end consisting of the cover 23 and the expansion vessel 24 assembled with springs 25 or by gluing, an upper insulating or metallic ring 26 glued with special resins to a glass fibre tube 27 to form a monolithic external insulating body, this glass fibre tube 27 being glued to the lower electrode 29, and a flange 28 and a closing terminal 30.

The flange 28 is also glued externally to this monolithic tube 27 which, in the part subjected to atmospheric agents, provides where necessary an external cover 31, generally made from organic polymers (silicone rubber or EPDM) provided with sheds 31′ made from the same material.

The final metallic foil of the capacitor-type insulating body 22 can be connected directly to the flange, normally at earth potential, by a spring contact through the two holes 32 and 33 formed in the insulating tube and in the flange respectively.

This connection can be insulated to control the capacitance and the dielectric losses, by means of a small bushing 35 which must in any cases be connected to the flange during operation.

In particular cases, when the capacitor-type insulating body is also to be used as a potential divider, the connection is; made to a last but one metallic or semiconducting foil.

With this solution, the following advantages are obtained:

1. All the intermediate seals, which can originate leakages, are eliminated.

2. The external glass fibre insulating tube 27 is made in one piece and is therefore monolithic, being able to withstand, owing to the mechanical characteristics of the material, even the maximum stresses to which it may be subjected during the service condition.

3. The mechanical stresses are further reduced by the fact that the structure is much lighter than that of the conventional solution, a property which also has positive effects on the packaging, carriage and assembling costs.

4. It is possible to reduce to a minimum the quantity of insulating fluid used for filling, with positive effects on the cost and weight, and, in the case of oil, on the reduction of the oil volume and consequently of the thermal dilatation compensation vessel.

In the case of an internal discharge, the insulating bushing has a much greater mechanical strength to explosion than the conventional bushing, especially since the upper end contains elements having their mechanical strength calibrated in such a way as to facilitate the release of the excess pressure due to an internal arc, without causing the ejection of fragments which can cause serious damage to the surrounding equipment.

What is claimed is:

1. Insulating bushing comprising a central conductor (21), an insulating body (22), an upper cover (23), an expansion vessel (24), an upper insulating ring (26), an external insulating envelope (27), a lower metallic electrode (29), a closing terminal (30) and a flange (28), characterized in that the external insulating envelope consists of a monolithic glass fibre insulating tube (27) incorporating the conductor (21) which supports the insulating body (22), the flange (28) being fitted externally on, and made integral with, the said monolithic insulating tube (27) by gluing, the insulating upper ring (26) and the lower metallic electrode (29) being also made integral with the said monolithic insulating tube (27) by gluing and therefore without the necessity of using seals.

2. Insulating bushing according to claim 1, characterized in that the upper insulating ring (26) is formed directly by wounding insulating material around the glass fibre tube (27).

3. Insulating bushing according to claims 1 and 2, characterized in that its structure is formed with materials having a high mechanical strength in order to prevent explosion due to instantaneous excess pressures arising from internal short circuits, with the exception of the closing terminal (30) of the cover (23) on the upper end, which is designed with a lower mechanical strength, and whose detachment permits the outflow of the pressurized gas.

4. Insulating bushing according to any one of claims 1 to 3, characterized in that the glass fibre insulating tube (27) is covered, in the part above the flange (28) or in both parts, by a cover (31) provided with sheds (31′) made from elastic polymer, for example silicone or EPDM.
